(19) United States
(12) Patent Application Publication
(10) Pub. No.: US 2005/0166012 A1
(43) Pub. Date: Jul. 28, 2005

(54) Method and system for cognitive pre-fetching

(76) Inventors: Yong Liu, Singapore (SG); BoonKhoon Sim, Singapore (SG)

Correspondence Address: Seagate Technology LLC, 1280 Disc Drive, Shakopee, MN, 55379, US

(21) Appl. No.: 10/764,846

(22) Filed: Jan. 26, 2004

(51) Int. Cl. G06F 12/08

(52) U.S. Cl. 711/112; 711/203

(57) ABSTRACT

According various embodiments of the present invention, methods and systems for accessing data on a storage medium of a data storage device comprise determining a file to be accessed based on a directory maintained by a host processor connected with the data storage device. One or more locations on the storage medium for data in the file to be accessed are found in a file system on the storage medium. A file location linked list is compiled based on the one or more locations on the storage medium for data in the file to be accessed. A download linked list command and the file location linked list is sent from the host to the data storage device.

### FIELD OF THE INVENTION

This application relates generally to data storage devices and more particularly to a cognitive pre-fetch of storage locations for data on a storage medium of a data storage device.

### BACKGROUND OF THE INVENTION

Increasingly, data storage devices such as disc drives, Compact Disc (CD) drives, Digital Video Disk (DVD) drives and others are being used to store large amounts of streaming data. For example, disc drives are used to store large amounts of streaming audio and/or video data in products like Personal Video Recorders (PVRs) and MP3 players.

Typically, a device such as a PVR will include a Central Processing Unit (CPU), a data storage device, some form of bridge such as an Application Specific Integrated Circuit (ASIC) for controlling communications between the CPU and data storage device, and a buffer memory for temporarily storing data being transferred to and from the data storage device. In use, a data stream is directly written to the buffer first. Once the buffer is full, the ASIC signals the CPU that the buffered data is ready to be transferred to the data storage device. While waiting for the buffer to be filled, the CPU is simultaneously calculating the Logical Block Addresses (LBAs) of the storage medium to access. Once computation is done, the host will generate a read/write command to the data storage device to transfer data from the buffer.

In typical audio/visual (A/V) applications, the file size can be very large. Therefore, the CPU needs to continuously calculate LBA locations and issue a substantial number of commands to transfer this amount of data. Because of this high computational overhead, a fast processor must be used. Additionally, since data is continuously streaming into and being storing in the buffer while waiting for the CPU to finish its computation, a large buffer is needed to cache this data. Therefore, such a method of storing streaming data demands a fast processor coupled with a large buffer results in increased manufacturing costs of consumer electronic devices such as PVRs, MP3 players and other devices. Further, as the streaming requirements like the number of data streams and data rate of each stream goes up, the device will need an even faster processor and a larger memory buffer.

Accordingly, there is a need for accurate knowledge of the data stream locations on the storage medium while reducing the computational and buffering requirements and remaining compatible with any file system that is implemented by the host. The present invention provides a solution to this and other problems, and offers other advantages over the prior art.

### SUMMARY OF THE INVENTION

Against this backdrop the present invention has been developed. According to one embodiment of the present invention, a method of accessing data on a storage medium of a data storage device comprises determining a file to be accessed based on a directory maintained by a host processor connected with the data storage device. One or more locations on the storage medium for data in the file to be accessed are found in a file system on the storage medium. A file location linked list is compiled based on the one or more locations on the storage medium for data in the file to be accessed. A download linked list command and the file location linked list is sent from the host to the data storage device.

According to another embodiment of the present invention, an apparatus comprises a data storage device having a rotatable storage medium. A host processor is communicatively connected with the data storage device. A memory is coupled with and readable by the processor. The memory has stored therein a series of instruction that, when executed by the processor, causes the processor to determine a file to be accessed based on a directory maintained by the host processor. One or more locations on the storage medium for data in the file to be accessed are found in a file system on the storage medium. A file location linked list is compiled based on the one or more locations on the storage medium for data in the file to be accessed. A download linked list command and the file location linked list is sent to the data storage device.

According to yet another embodiment of the present invention, a data storage device comprises a rotatable storage medium, a processor communicatively coupled with the rotatable storage medium and a host processor, and a memory coupled with and readable by the processor. The memory has stored therein a series of instruction that, when executed by the processor, cause the processor to receive a download linked list command and a file location linked list from the host processor. The file location linked list indicates one or more Logical Block Addresses (LBAs) to be accessed and a sector count to be accessed at each LBA.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive in accordance with an embodiment of the present invention illustrating the primary internal components of the disc drive.

FIG. 2 is a control block diagram for the disc drive shown in FIG. 1 illustrating the primary functional components.

FIG. 3 depicts a plurality of concentric tracks on a disc of the disc drive, illustrating the manner in which data is typically stored on the disc.

FIG. 4 illustrates an architecture of a device upon which embodiments of the present invention may be implemented.

FIG. 5 illustrates one possible format for a file location linked list according to one embodiment of the present invention.

FIG. 6 is a flowchart illustrating a host command process according to another embodiment of the present invention.

FIG. 7 is a flowchart illustrating a data storage device read command process according to yet another embodiment of the present invention.

FIG. 8 is a flowchart illustrating a data storage device write command process according to another embodiment of the present invention.

FIG. 9 is a flowchart illustrating a data storage device seek offset command process according to yet another embodiment of the present invention.

### DETAILED DESCRIPTION

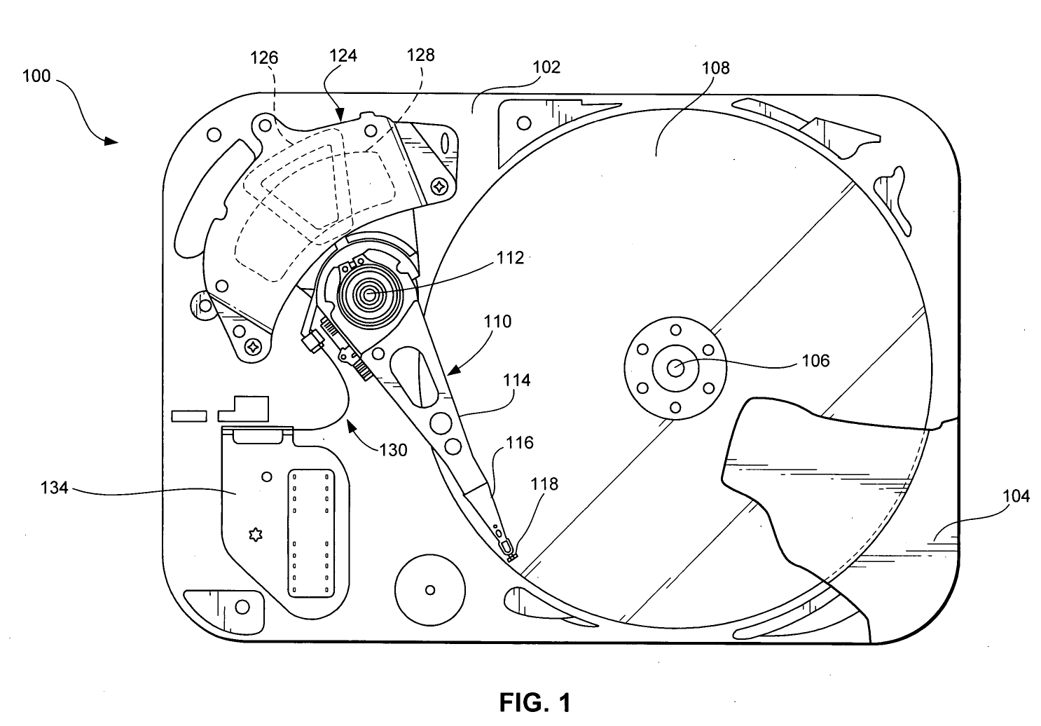

Embodiments of the present invention will be discussed with reference to a data storage device that, in one embodiment may be a magnetic disc drive such as disc drive 100 illustrated in FIG. 1. One skilled in the art will recognize that the present invention may also be applied to any data storage device, such as an optical disc drive, a magneto-optical disc drive, or other data storage device that utilizes a file system such as a file allocation table on the storage medium.

FIG. 1 is a plan view illustrating the primary internal components of a disc drive incorporating one of the various embodiments of the present invention. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes a fluid bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved away from portions of the disc 108 containing data when the drive motor is de-energized. The heads 118 are secured over portions of the disc not containing data through the use of an actuator latch arrangement and/or ramp, which prevents inadvertent rotation of the actuator assembly 110 when the drive discs 108 are not spinning.

A flex assembly 130 provides the requisite electrical connection paths for the actuator assembly 110 while allowing pivotal movement of the actuator assembly 110 during operation. The flex assembly includes a printed circuit board 134 to which a flex cable leading to the head is connected; the flex cable leading to the heads 118 being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

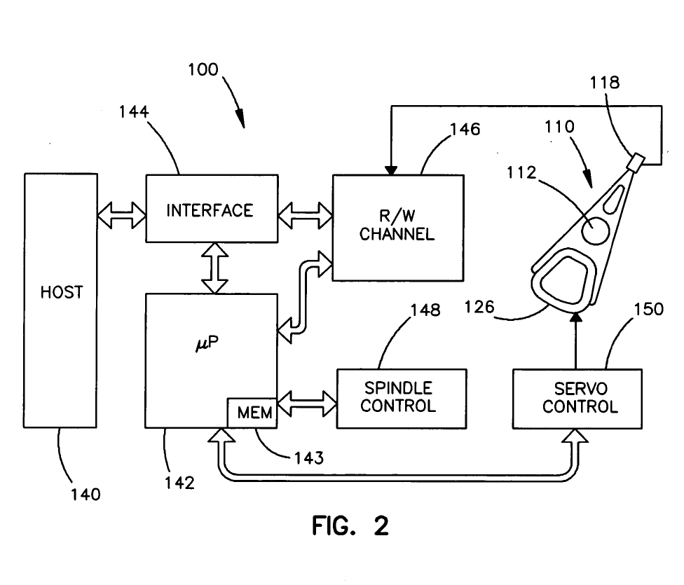

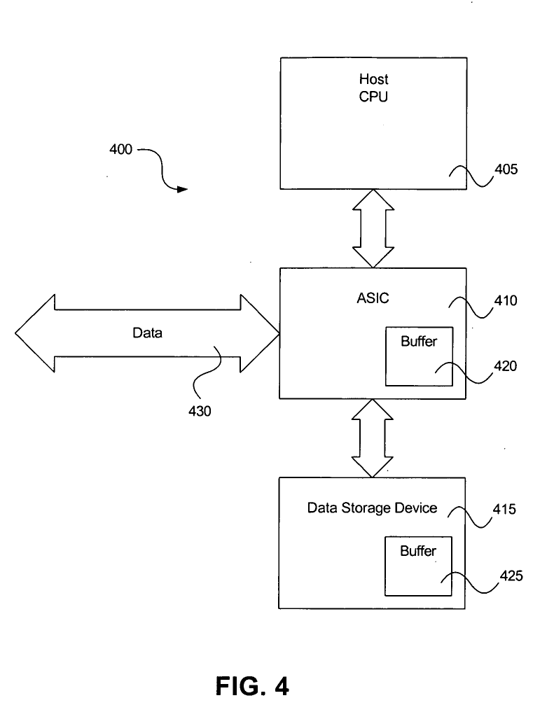

FIG. 2 is a control block diagram for the disc drive 100 illustrating the primary functional components of a disc drive incorporating one of the various embodiments of the present invention and generally showing the main functional circuits which are resident on the disc drive printed circuit board and used to control the operation of the disc drive 100. The disc drive 100 is operably connected to a host computer 140 in a conventional manner. Control communication paths are provided between the host computer 140 and a disc drive microprocessor 142, the microprocessor 142 generally providing top level communication and control for the disc drive 100 in conjunction with programming for the microprocessor 142 stored in microprocessor memory (MEM) 143. The MEM 143 can include random access memory (RAM), read only memory (ROM) and other sources of resident memory for the microprocessor 142. Instructions stored in MEM 143 and executable by the microprocessor 142 may include instructions for arranging information stored on the disc 108 as will be discussed below with reference to FIGS. 4-8.

The discs 108 are rotated at a constant high speed by a spindle motor control circuit 148, which typically electrically commutates the spindle motor 106 (FIG. 1) through the use, typically, of back electromotive force (BEMF) sensing. During a seek operation, wherein the actuator 110 moves the heads 118 between tracks, the position of the heads 118 is controlled through the application of current to the coil 126 of the voice coil motor 124. A servo control circuit 150 provides such control. During a seek operation the microprocessor 142 receives information regarding the velocity of the head 118, and uses that information in conjunction with a velocity profile stored in memory 143 to communicate with the servo control circuit 150, which will apply a controlled amount of current to the voice coil motor coil 126, thereby causing the actuator assembly 110 to be pivoted.

Data is transferred between the host computer 140 or other device and the disc drive 100 by way of an interface 144, which typically includes a buffer to facilitate high-speed data transfer between the host computer 140 or other device and the disc drive 100. Data to be written to the disc drive 100 is thus passed from the host computer 140 to the interface 144 and then to a read/write channel 146, which encodes and serializes the data and provides the requisite write current signals to the heads 118. To retrieve data that has been previously stored in the data storage device 100, read signals are generated by the heads 118 and provided to the read/write channel 146, which performs decoding and error detection and correction operations and outputs the retrieved data to the interface 144 for subsequent transfer to the host computer 140 or other device.

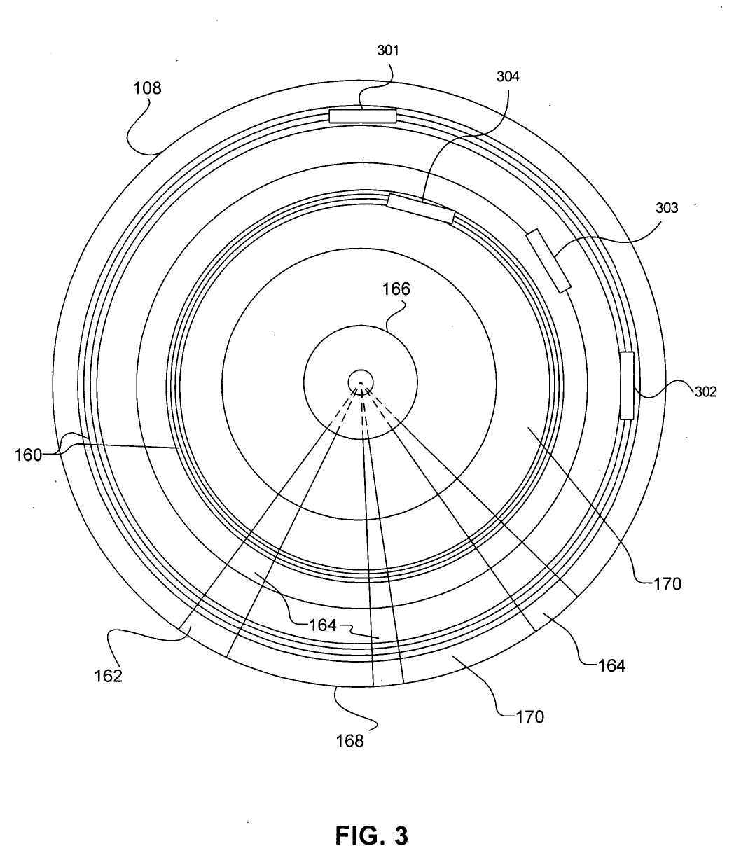

FIG. 3 depicts a plurality of concentric tracks on a storage medium such as disc 108 of the disc drive 100, illustrating the manner in which data is typically stored on the disc 108. Shown here is a plan view of the disc 108, generally showing the main components on the surface of the disc 108. The discs 108 are circumferentially divided into a plurality of concentric circular tracks 160. The number of tracks 160 per disc 108 will vary with each particular manufactured disc 108. A one-time revolution (INDEX) around each track 160 is typically indicated by an index mark 162 that extends the radius of the disc 108. The tracks 160 are in groups, called zones 170, in which the recording frequency is substantially the same among the tracks 160.

The disc 108 is radially divided into a plurality of servo segments 164. Typically, the servo segments 164 begin near the inner edge 166 of the annular disc 108 and terminate near the outer edge 168 of the disc 108. As with the number of tracks 160 per disc 108, the number of servo segments 164 per disc 108 varies with each particular manufactured disc 108. Each track 160 is composed of spaced servo segments 164 with data sectors between the servo segments 164.

Typically, when accessing data the head seeks to a track where the data resides and waits for the data to “spin” to the head. Each seek and wait implies a performance hit since no data is transferred during this time. To further illustrate this problem, FIG. 3 illustrates a file divided into 4 segments 301-304 and stored at various locations on the disc 108. In this example, segment 301 represents the beginning of the file while segments 302-304 each respectively represent subsequent portions of the file. A typical sequence would be to read the segments in order from 301 to 304 consecutively. If the disc 108 is rotating in a counterclockwise direction and the head is located at an arbitrary position, the head would have to wait for the disc to make roughly ¼ of a revolution to get to segment 302 after reading segment 301. From segment 302 to 303 would require almost a full revolution. An additional revolution would be required between segments 303 and 304.

According to one embodiment of the present invention, the read/write location sequence can be re-arranged to minimize the seek and wait time. That is, with a cognitive prefetch, the firmware will re-arrange the sequence to read segments 301, 304, 303 and 302. In this method, the disc only needs to make ¼ revolution to complete the whole read process as compared to 3 revolutions in the previous example. Alternatively, the read/write sequence may be arranged to provide the segments in the order in which they are arranged in the file.

FIG. 4 illustrates an application architecture upon which embodiments of the present invention may be implemented. This example may represent a Personal Video Recorder (PVR), MP3 player, or any other type of device used to store large amounts of streaming data. As illustrated here, the device 400 includes a host Central Processing Unit (CPU) 405, a data storage device 415, and an Application Specific Integrated Circuit (ASIC) 410 acting as a bridge between the host CPU 405 and the data storage device 415 as well as providing an input/output data channel 430.

In this device 400, the host CPU 405 accesses data on the data storage device 415 by first compiling a list of LBA locations on the storage medium of the data storage device 415 to be accessed before any actual data transfer is initiated. Generally, the host CPU 405 reads the file system of the data storage device 415 such as a file allocation table to locate all segments of the file to be accessed. The host CPU 405 then determines an order in which these segments should be accessed and adds the LBAs and sector counts for each segment to a file location linked list to be used for accessing the data. Additional details of this list and the host CPU process for issuing commands will be discussed further below.

The host CPU 405, after compiling the file location linked list, sends the list to the data storage device 415 along with a download command. The data storage device will then access data based on this list in response to read/write commands. In some cases the read/write commands may be issued by the host CPU 405. Alternatively, the ASIC 410 can be configured to take over the issuance of read/write commands from the host CPU 405.

Therefore, the host CPU 405 need not constantly calculate LBAs while the data is being accessed. Additionally, if the ASIC is configured to issue read/write commands, the host need not perform the processing required to issue these commands. The CPU cycles saved can therefore be utilized for other applications. Alternatively, a slower, cheaper CPU will be sufficient to meet the overall requirement of the device.

Having identified and ordered the LBA locations to be accessed before requesting any access, there is no need for a large buffer to cache the data since there is no need to read ahead of the requested data. Therefore, a smaller buffer may be used relative to similar devices using previous methods of accessing the data storage device. This buffer 420 can be small enough that, in some cases, it may be embedded in the ASIC 410. Additionally, the read/write buffer 425 in the data storage device 415 can also serves as the data cache for the A/V data.

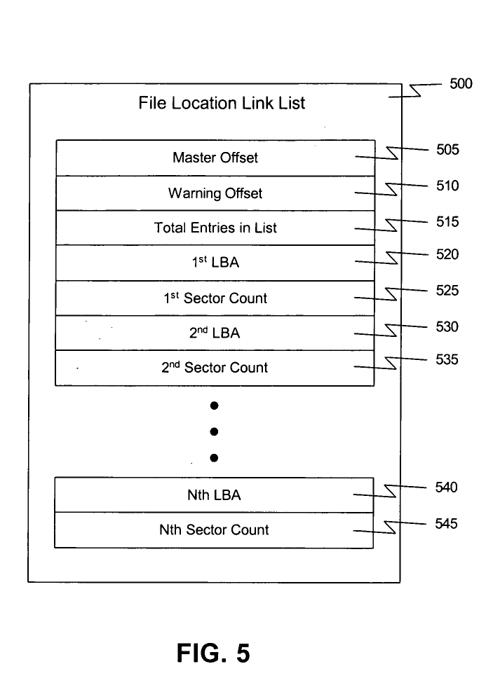

As introduced above, the location of a file on the storage medium of the data storage device can be described by a linked list of LBA sectors. FIG. 5 illustrates one possible format for a file location linked list according to one embodiment of the present invention. This example shows a file location linked list 500 comprising a master offset element 505, a warning offset element 510, a total entries element 515, and a series of one or more LBA and sector count pairs such as 1^{st} LBA 520 and 1^{st} sector count 525 up to N^{th} LBA 540 and N^{th} sector count 545.

The master offset element 505 represents the current LBA offset from the first LBA of the file. That is, if the file is represented by more than one file location linked list, the master offset element 505 can be used to indicate the overall position in the file of the portion represented by the current list.

The warning offset element 510 represents the position within the list where the data storage device will signal the host for a new list. As will be seen below, the data storage device maintains an internal position counter that indicates the position of the last read/write. When this counter reaches the warning offset, which preferably indicates a position prior to but near the end of the list, the data storage device will interrupt the host CPU to request a new linked list if one is available.

The total entries element 515 represents the total capacity, in sectors, represented in the list.

The 1 st LBA element indicates the LBA location of the first segment of the file to be accessed while the 1 st sector count 525 indicates the size of that segment in sectors. Similarly, the 2nd LBA 530 and 2nd sector count 535 indicate the size and location of the second segment of the file and so on up to the Nth LBA 540 and Nth sector count 545. Therefore, as will be explained further below, once the data storage device receives a read/write command, it can begin accessing the storage medium as indicated by the LBA and sector count pairs in the list 500.

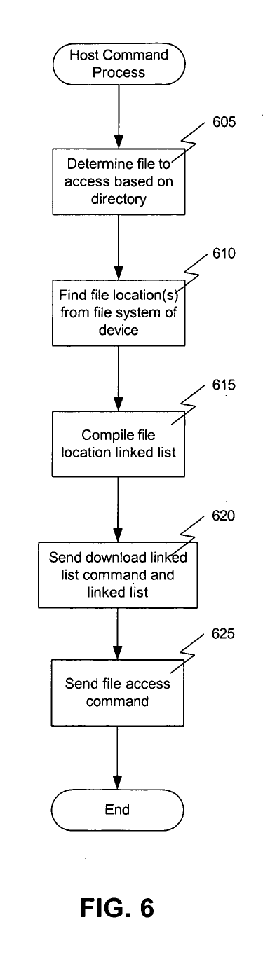

FIG. 6 is a flowchart illustrating a host side command process according to one embodiment of the present invention. Here, operation begins with determination operation 605. Determination operation 605 comprises determining a file to be accessed based on a directory maintained by a host processor connected with the data storage device. That is, the host reads the directory of whatever file system it is using to determine which file contains the desired data. Control then passes to find operation 610.

Find operation 610 comprises finding from a file system on the storage medium one or more locations on the storage medium for data in the file to be accessed. For example, the data storage device may utilize a file allocation table or similar structure stored on the storage medium to identify the location of information stored on the medium. Once the host has identified the desired file, it can read the file system of the data storage device to locate the sectors in which that file is stored on the storage medium. Similarly, the file system of the data storage device can be read to identify free space in which the file may be written. Control then passes to compile operation 615.

Compile operation 615 comprises compiling a file location linked list based on the one or more locations on the storage medium for data in the file to be accessed. Compiling the file location linked list may also comprises arranging entries in the file location linked list based on a Logical Block Address (LBA) for the one or more locations on the storage medium for data in the file to be accessed. That is, the entries in the file location link list may be arranged in an order in which they may be read to reduce seeking and rotational latency. Control then passes to send operation 620.

Send operation 620 comprises sending a download linked list command and the file location linked list from the host to the data storage device. Control then passes to send operation 625.

Send operation 625 comprises sending a file access command to the data storage device. As will be discussed below, the file access command may be a read command, a write command or a seek offset command.

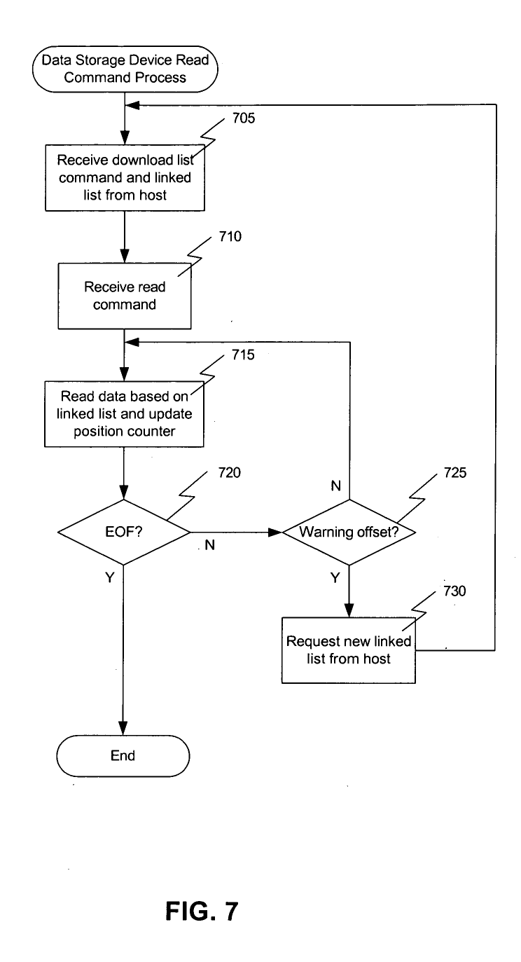

FIG. 7 is a flowchart illustrating a data storage device read command process according to one embodiment of the present invention. Operation begins with receive operation 705. Receive operation 705 comprises receiving the download linked list command and the file location linked list from the host. Control then passes to receive operation 710.

Receive operation 710 comprises receiving the read command. Control then passes to read operation 715.

Read operation 715 comprises reading data from a number of sectors of the storage medium of the data storage device indicated in the file location linked list beginning at a Logical Block Address (LBA) indicated in the file location linked list. Additionally, a position counter maintained by the data storage device to indicate the current position will be updated based on the number of sectors read. Control then passes to query operation 720.

Query operation 720 comprises determining whether the end of file marker for the current file has been reached. If a determination is made at query operation 720 that the end of file marker has been reached, no further processing will be performed. If a determination is made that the end of file marker has not been reached, control passes to query operation 725.

Query operation 725 comprises comparing the position counter maintained by the data storage device to the warning offset value in the file location linked list. If the position counter exceeds the warning offset value in the file location linked list control passes to request operation 730. Request operation 730 comprises requesting a new file location linked list from the host.

If, at query operation 725, a determination is made that the position counter has not exceeded the warning offset value, control returns to read operation 715. In this manner, the data storage device will continue to read data from the storage medium as indicated by the LBA and sector count pairs in the file location list until the warning offset value is exceeded. Once the warning offset is exceeded, the data storage device will request a new file location list.

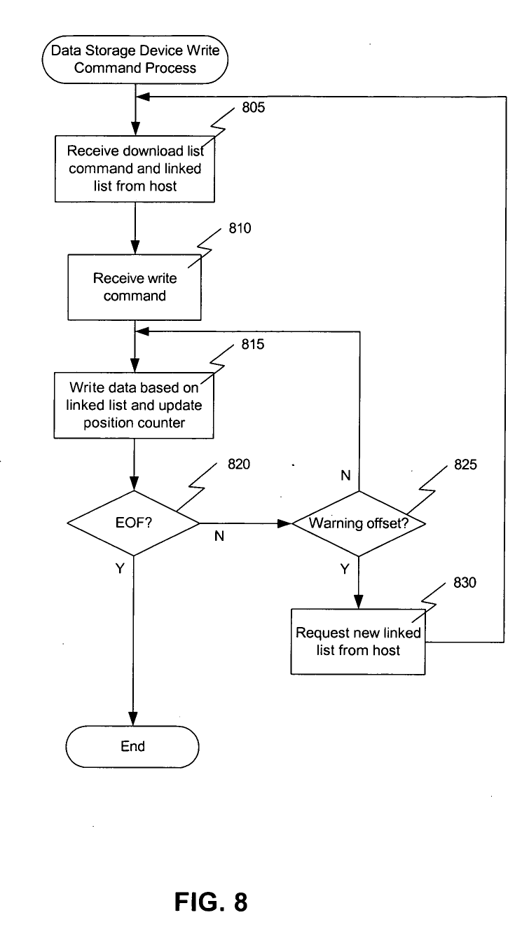

FIG. 8 is a flowchart illustrating a data storage device write command process according to one embodiment of the present invention. Here, operation begins with receive operation 805. Receive operation 805 comprises receiving the download linked list command and the file location linked list from the host. Control then passes to receive operation 810.

Receive operation 810 comprises receiving the write command. Control then passes to write operation 815.

Write operation 815 comprises writing data to a number of sectors of the storage medium of the data storage device indicated in the file location linked list beginning at a Logical Block Address (LBA) indicated in the file location linked list. Additionally, a position counter maintained by the data storage device to indicate the current position will be updated based on the number of sectors written. Control then passes to query operation 820.

Query operation 820 comprises determining whether the end of file marker for the current file has been reached. If a determination is made at query operation 820 that the end of file marker has been reached, no further processing will be performed. If a determination is made that the end of file marker has not been reached, control passes to query operation 825.

Query operation 825 comprises comparing the position counter maintained by the data storage device to the warning offset value in the file location linked list. If the position counter exceeds the warning offset value in the file location linked list control passes to request operation 830. Request operation 830 comprises requesting a new file location linked list from the host.

If, at query operation 825, a determination is made that the position counter has not exceeded the warning offset value, control returns to write operation 815. In this manner, the data storage device will continue to write data to the storage medium as indicated by the LBA and sector count pairs in the file location list until the warning offset value is exceeded. Once the warning offset is exceeded, the data storage device will request a new file location list.

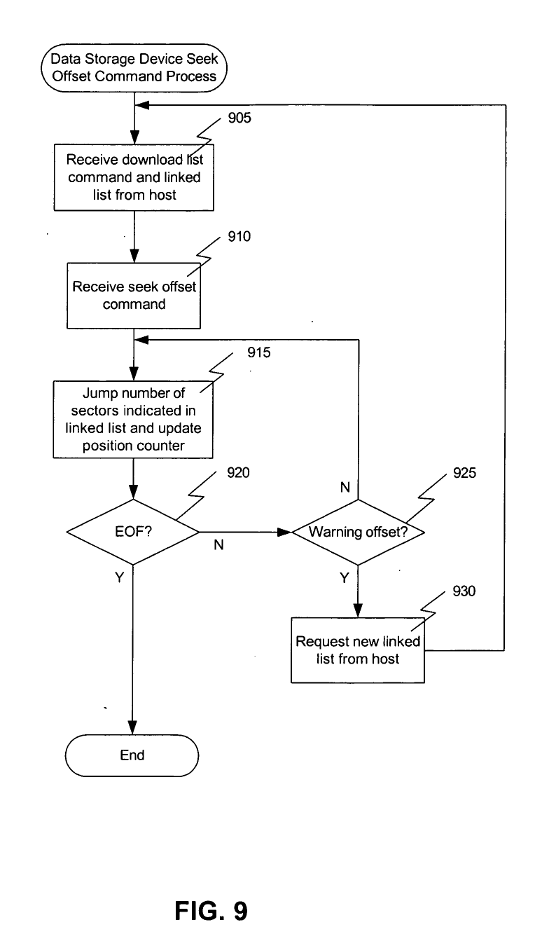

FIG. 9 is a flowchart illustrating a data storage device seek offset command process according to one embodiment of the present invention. Operation begins with receive operation 905. Receive operation 905 comprises receiving the download linked list command and the file location linked list from the host. Control then passes to receive operation 910.

Receive operation 910 comprises receiving the seek offset command. Control then passes to seek operation 915.

Seek operation 915 comprises jumping a number of sectors of the storage medium of the data storage device indicated in the compiled linked list from a current position. The seek may be either forward or backward depending on an indication that may be part of the seek offset command. Additionally, a position counter maintained by the data storage device to indicate the current position will be updated based on the number of sectors read. Control then passes to query operation 920.

Query operation 920 comprises determining whether the end of file marker for the current file has been reached. If a determination is made at query operation 920 that the end of file marker has been reached, no further processing will be performed. If a determination is made that the end of file marker has not been reached, control passes to query operation 925.

Query operation 925 comprises comparing the position counter maintained by the data storage device to the warning offset value in the file location linked list. If the position counter exceeds the warning offset value in the file location linked list control passes to request operation 930. Request operation 930 comprises requesting a new file location linked list from the host.

If, at query operation 925, a determination is made that the position counter has not exceeded the warning offset value, control returns to seek operation 915. In this manner, the data storage device will continue to seek as indicated by the file location list until the warning offset value is exceeded. Once the warning offset is exceeded, the data storage device will request a new file location list.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, various types of data storage devices other than disc drives may be used. Numerous other changes may be made which will readily suggest themselves to those skilled in the art and which are encompassed in the spirit of the invention disclosed and as defined in the appended claims.

1. A method of accessing data on a storage medium of a data storage device comprising:
determining a file to be accessed based on a directory maintained by a host processor connected with the data storage device;
finding from a file system on the storage medium one or more locations on the storage medium for data in the file to be accessed;
compiling a file location linked list based on the one or more locations on the storage medium for data in the file to be accessed; and
sending a download linked list command and the file location linked list from the host to the data storage device.

2. The method of claim 1, wherein compiling the file location linked list comprises arranging entries in the file location linked list based on a Logical Block Address (LBA) for the one or more locations on the storage medium for data in the file to be accessed.

3. The method of claim 1, further comprising sending a file access command to the data storage device.

4. The method of claim 3, wherein the file access command is a read command.

5. The method of claim 4, wherein the data storage device accesses data on the storage medium by:
receiving the download linked list command and the file location linked list from the host;
receiving the read command;
reading data from a number of sectors of the storage medium of the data storage device indicated in the file location linked list beginning at a Logical Block Address (LBA) indicated in the file location linked list; and
updating a position counter based on a number of sectors read.

6. The method of claim 5, further comprising requesting a new file location linked list if the position counter exceeds a warning offset value in the file location linked list.

7. The method of claim 3, wherein the file access command is a write command.

8. The method of claim 7, wherein the data storage device accesses data on the storage medium by:
receiving the download linked list command and the compiled linked list from the host;
receiving the write command from the host;
writing a stream of data from the host to a number of sectors of the storage medium of the data storage device indicated in the file location linked list beginning at a Logical Block Address (LBA) indicated in the compiled linked list; and
updating a position counter based on a number of sectors written.

9. The method of claim 8, further comprising requesting a new file location linked list if the position counter exceeds a warning offset value in the file location linked list.

10. The method of claim 3, wherein the file access command is a seek offset command.

11. The method of claim 10, wherein the data storage device accesses data on the storage medium by:
receiving the download linked list command and the compiled linked list from the host;
receiving the seek offset command from the host;
jumping a number of sectors of the storage medium of the data storage device indicated in the file location linked list from a current position; and
updating a position counter based on the seek offset value.

12. An apparatus comprising:
a data storage device having a storage medium;
a host processor communicatively connected with the data storage device; and
a memory coupled with and readable by the processor and having stored therein a series of instruction that, when executed by the processor, causes the processor to determine a file to be accessed based on a directory maintained by the host processor, find from a file system on the storage medium one or more locations on the storage medium for data in the file to be accessed, compile a file location linked list based on the one or more locations on the storage medium for data in the file to be accessed, and send a download linked list command and the file location linked list to the data storage device.

13. The apparatus of claim 12, wherein compiling the file location linked list comprises arranging entries in the file location linked list based on a Logical Block Address (LBA) for the one or more locations on the storage medium for data in the file to be accessed.

14. The apparatus of claim 12, wherein the host processor further sends a read command to the data storage device.

15. The apparatus of claim 13, wherein the data storage device receives the download linked list command and the file location linked list from the host processor, receives the read command, reads data from a number of sectors of the storage medium of the data storage device indicated in the file location linked list beginning at a Logical Block Address (LBA) indicated in the file location linked list, updates a position counter based on a number of sectors read, and requests a new file location linked list if the position counter exceeds a warning offset value in the file location linked list.

16. The apparatus of claim 12, wherein the host processor further sends a write command to the data storage device.

17. The apparatus of claim 16, wherein the data storage device receives the download linked list command and the compiled linked list from the host processor, receives the write command from the host processor, writes a stream of data from the host processor to a number of sectors of the storage medium of the data storage device indicated in the compiled linked list beginning at a Logical Block Address (LBA) indicated in the file location linked list, updates a position counter based on a number of sectors written, and requests a new file location linked list if the position counter exceeds a warning offset value in the file location linked list.

18. The apparatus of claim 12, wherein the host processor further sends a seek offset command to the data storage device.

19. The apparatus of claim 18, wherein the data storage device receives the download linked list command and the compiled linked list from the host processor, receives the seek offset command from the host processor, jumps a number of sectors of the storage medium of the data storage device indicated in the file location linked list from a current position, and updates a position counter based on the seek offset value.

20. A data storage device comprising:
a storage medium;
a processor communicatively coupled with the storage medium and a host processor; and
a memory coupled with and readable by the processor and having stored therein a series of instruction that, when executed by the processor, cause the processor to receive a download linked list command and a file location linked list from the host processor, the file location linked list indicating one or more Logical Block Addresses (LBAs) to be accessed and a sector count to be accessed at each LBA.

21. The data storage device of claim 20, wherein the processor, responsive to receiving a read command, reads data from a number of sectors of the storage medium indicated in the file location linked list beginning at a Logical Block Address (LBA) indicated in the file location linked list, updating a position counter based on a number of sectors read, and requests a new file location linked list if the position counter exceeds a warning offset value in the file location linked list.

22. The data storage device of claim 20, wherein the processor, responsive to receiving a write command, writes a stream of data from the host to a number of sectors of the storage medium indicated in the file location linked list beginning at a Logical Block Address (LBA) indicated in the file location linked list, updates a position counter based on a number of sectors written, and requests a new file location linked list if the position counter exceeds a warning offset value in the file location linked list.

23. The data storage device of claim 20, wherein the processor, responsive to receiving a seek offset command, jumps a number of sectors of the storage medium indicated in the file location linked list from a current position, and updating a position counter based on the seek offset value.
